(19) United States
(12) Patent Application Publication
(10) Pub. No.: US 2009/0288274 A1
(43) Pub. Date: Nov. 26, 2009

(54) DEVICE FOR FASTENING SAFETY AND WORKING ROPES ON TELESCOPIC COLUMNS OF APPARATUS FOR LIFTING BOARDS ONTO CEILINGS AND WALLS

(75) Inventor: Denis NARELLI, Saint Haon Le Chatel (FR)

Correspondence Address: HESLIN ROTHENBERG FARLEY & MESITI PC, 5 COLUMBIA CIRCLE, ALBANY, NY, 12203, US

(73) Assignee: ROGER MONDELIN SAS, Ambierle (FR)

(21) Appl. No.: 12/463,638

(22) Filed: May 11, 2009

(30) Foreign Application Priority Data
May 23, 2008 (FR) 0853365

(51) Int. Cl. F16G 11/00

(52) U.S. Cl. 24/128

(57) ABSTRACT

A device is fixed horizontally on an accommodating column of alternative profiles, and include an L shaped plate with a horizontal face and a vertical face connected together by a curved central section having a wide radius. The plate has two parallel and identical oblong holes formed in a height of the plate. These holes allow the positioning and passage of traction and safety ropes. The ropes having at their ends stops coming into contact with a lower side of the plate.

### CROSS REFERENCE TO RELATED APPLICATIONS

This application claims priority of French application no. 0853365, filed on May 23, 2008, the entire disclosure of which is hereby incorporated herein.

### BACKGROUND ART

The invention relates to the technical field of apparatus for lifting and handling boards of composite wood, plaster or other materials intended to be positioned onto ceilings and/or onto the wall or walls of a structure.

These large boards constitute heavy loads to be moved and positioned, and apparatus of this type use telescopic masts mounted manually by a winch. A rope safety device is accordingly provided, which ensures that, in case of breakage of the traction rope used to raise or lower the columns constituting the mast, a supplementary safety rope is then activated to substitute for the broken traction rope. A safety device of this type has been described in french patent no. 2538437, and was then improved by the device described in french patent no. 2758150 to the applicant. This patent is used by the applicant satisfactorily. FIG. 1 of the application shows the safety device known from the prior art in french patent no. 2758150. It uses a particular arrangement with two ropes, one for traction and the other for safety by substitution, these two ropes being looped and anchored at one of their ends separately to two pins joined to the bottom end of the terminal column of the mast with different positioning levels. Thus, the safety rope is longer than the traction rope, with an assembly that reveals a clearance between its lowest point and the retaining pin, in order to avoid being loaded in normal periods. This safety rope is kept under tension by means of a spring of which one of the ends is joined to the loop of the rope, and the other is joined to the inside column by means of a hole for hooking.

While this device is commonly used by the applicant, the implementation of its assembly is not always practical. The device is accommodated inside the terminal column of the telescopic mast, as shown in FIG. 2 of abovementioned french patent no. 2758150.

In connection with new researches, the applicant has externalized the tension of the safety rope with regard to the vertical column of the telescopic mast to facilitate the assembly of the overall safety device. For this purpose, this solution has been described in patent application fr 06.055264 and has been illustrated partially in FIGS. 2a-2b.

The safety device comprises, on the one hand, a part (1) for hooking and fastening the traction (2) and safety (3) ropes, so that they are at the same fastening level, the said hooking part being fastened in the lower accommodating portion (4a) of the terminal internal column (4) of the telescopic assembly and, on the other hand, a mechanism for tensioning the safety rope (3), this mechanism being externalized with regard to the telescopic mast and located opposite the winch for winding the traction and safety ropes. The hooking part (1) is prepared in the form of a profiled plate having, in its upper top proportion (1a) in its inside, two terminals (1b) spaced and projecting from the flat base (1c) of the plate. Each terminal allows the passage and fastening of the anchoring loops (2a) (3a) formed at the ends of the traction and safety ropes. The loops (2a) (3a) surround the abovementioned terminals and are therefore kept under tension by the ropes which are directed towards the winch. The bottom portion (1d) of the hooking part (1) has an inward offset (1e) so as to be anchored in the space formed for this purpose on the lower portion of the terminal internal column of the telescopic mast.

This latter solution, although advantageous, reveals a number of drawbacks concerning the strength of the end loops of the traction and safety ropes, and of the hooking plate itself with regard to the accommodating tube.

The profiles of the telescopic columns of telescopic masts for lifting apparatus may, furthermore, have different triangular configurations with an open square or rectangular section face. According to known practice, the hooking devices of the safety and traction ropes must take account of the differentiations of profiles and have very different configurations.

Thus, it is a further aspect of the invention to produce a novel device having an identical functionality, regardless of the profile of the uprights.

The applicant's approach was therefore to reflect on an improvement to the fastening of the said ropes, and also on the amplitude imparted to the trajectory of the safety rope to give it more slack in comparison with the working rope in an operating situation.

A further aspect was to obtain longer rope service life.

Faced with these various aspects, the applicant revisited the device for fixing and hooking the ends of the safety and traction ropes in an optimized configuration.

### BRIEF SUMMARY OF INVENTION

According to a first feature, the device for fastening safety and working ropes on telescopic columns of apparatus for lifting boards onto ceilings and walls, of the type comprising a part for hooking the traction and safety ropes being positioned on the internal column of the telescopic mast of the apparatus, is characterized in that the device is fixed horizontally on the accommodating column in the alternative profiles thereof, and consists of a 1 shaped plate with a horizontal face and a vertical face connected together by a curved central shape having a wide radius, and in that the said plate is arranged with two parallel and identical oblong holes formed in the height of the plate, and in that these holes allow the positioning and passage of traction and safety ropes, the said ropes having at their ends stops coming into contact with the lower side of the plate.

These features and others will appear clearly from the rest of the description.

### BRIEF DESCRIPTION OF THE DRAWING FIGURES

To clarify the object of the invention, it is illustrated in a non-limiting manner in the figures of the drawings in which:

FIG. 1 is a partial view showing the safety device of the prior art described in patent FR 2.758.150.

FIG. 2A is a partial view showing the safety device in an alternative embodiment according to patent FR 06.055264.

FIG. 2B is a view, according to FIG. 2A, of the plate for hooking the safety and traction ropes, according to patent FR 06.055264.

FIG. 3 is a partial view showing the device for fastening and hooking the safety and traction ropes in an open column of an upright for a lifting apparatus, according to the invention. The column has a triangular profile.

FIG. 3A is a partial view of the hooking plate itself in a ¾ perspective position.

FIG. 4 is a cross section showing the assembly of the device, according to FIGS. 3, 3A.

FIG. 5 is a partial side view showing the rope hooking device adapted to a closed column of an upright for a lifting apparatus, the column having a square or rectangular section profile.

FIG. 5A is a view of the hooking plate used in the implementation of FIG. 5.

FIG. 6 is a partial view showing the adaptation of the inventive device on a deployed closed column of a telescopic mast for lifting apparatus.

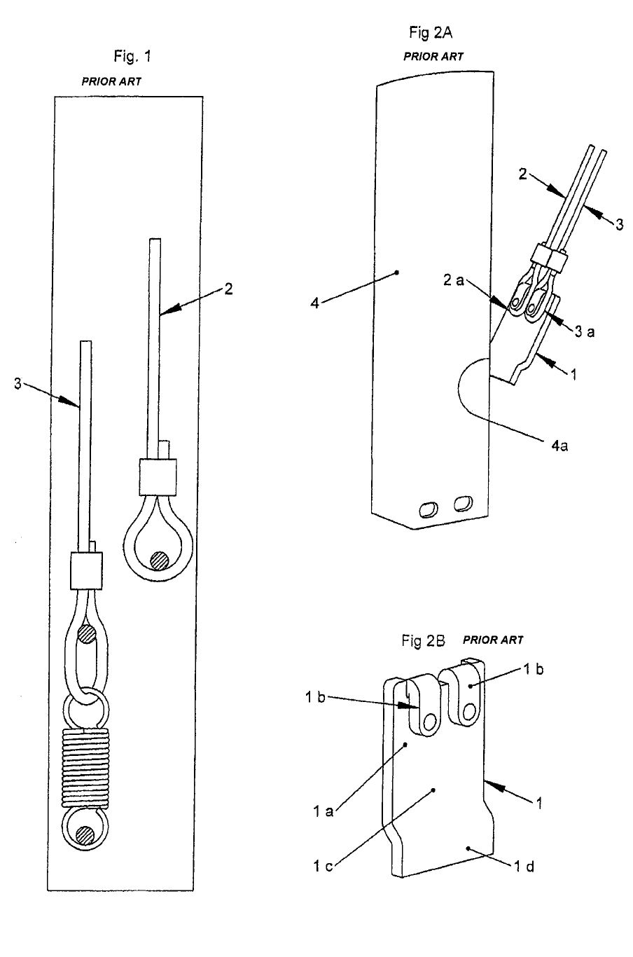

### DETAILED DESCRIPTION

To make the object of the invention more concrete, it is now described in a non-limiting manner illustrated in the appended figures of the drawings.

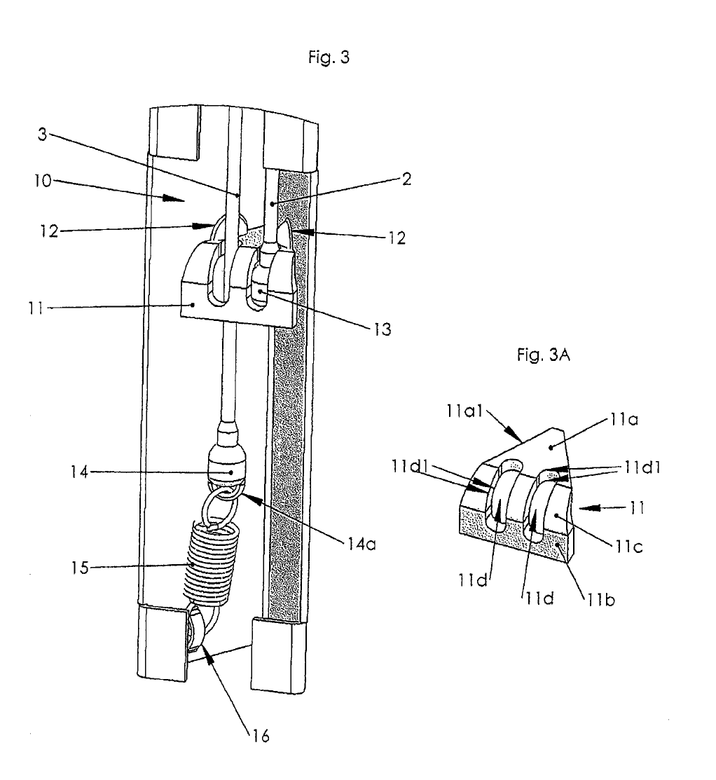

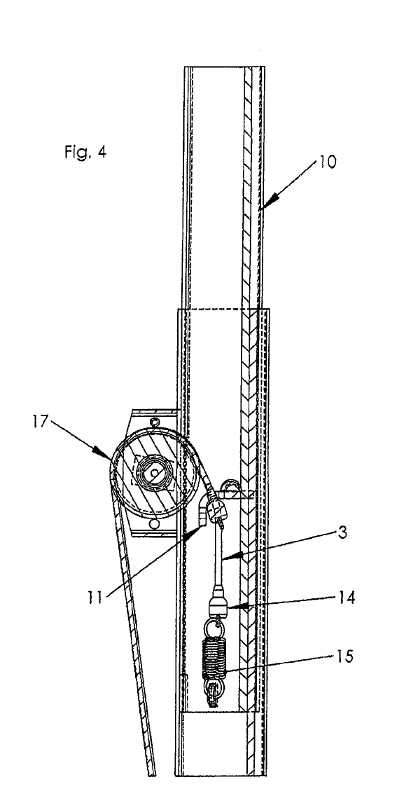

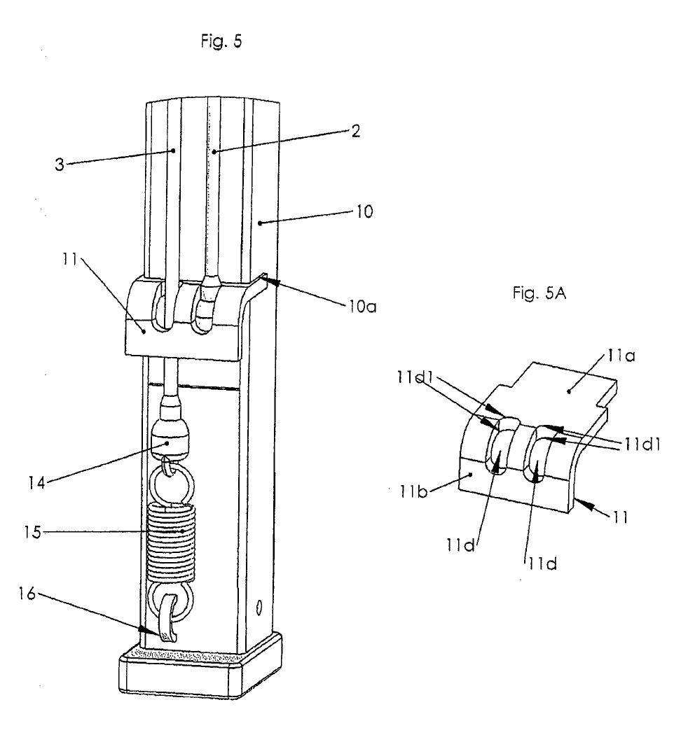

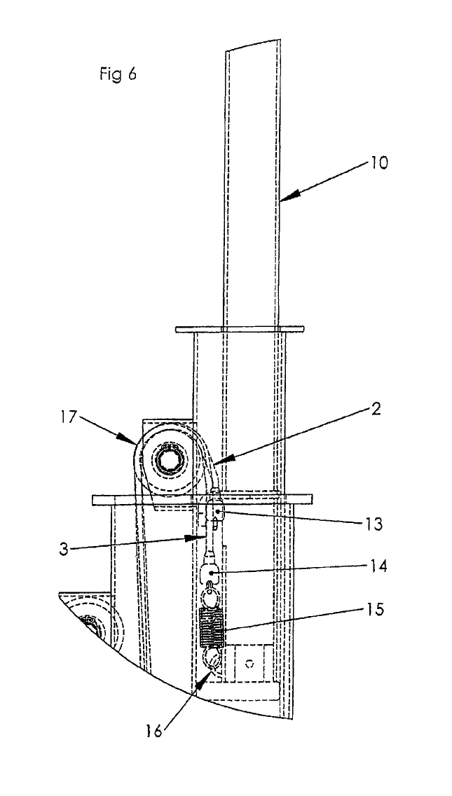

The columns (10) constituting the mast of the board lifting and handling apparatus have an open profile or a closed profile and both alternatives have been shown in the figures, one with an open triangular profile, FIGS. 3, 3a, 4, and the other with the closed profile, FIGS. 5, 5a, 6, from which the hooking device (11) for the safety (3) and traction (2) ropes is disposed. This device (11) is suitable for being fastened horizontally to the accommodating column in the alternatives having the abovementioned profile. According to the invention, the hooking device (11) consists of a l shaped plate with a horizontal face (11a) and a vertical face (11b) connected together by a curved central shape (11c) having a wide radius. This plate is thus arranged with two parallel and identical oblong holes (11d) formed in the height of the plate. These holes have in the top and bottom ends, rounded shapes (11d1) for a better guidance of the ropes and for preventing their deterioration by scraping, as will appear below. These holes (11d) are prepared on the whole curved portion (11c) but also on part of the horizontal and vertical faces, as it appears in FIGS. 3a and 5a in particular. These holes have the function of allowing the passage of the safety (3) and traction (2) ropes and their holding, and also to follow the winding trajectory of the said ropes on the pulleys (17) (FIGS. 4 and 6) located in the upper portion of the intermediate column of the telescopic mast, whenever the terminal internal column (10) accommodating the device is fully deployed. The profiled plate (11), according to the invention, has a horizontal upper face (11a) which is profiled according to the geometric configuration of the accommodating column. As illustrated in FIGS. 3, 3a, 4, the column is open with a triangular profile. Thus, the horizontal lug shaped face (11a) is also in a triangular configuration (11a1) and comes into contact with the opposite wall of the column. The plate is fixed by welding, adhesive or other means against the opposite portions of the column. The back-support stops (12) are disposed on the insides of the accommodating column and serve to stabilize the plate in position. This profile is non-limiting and it is also conceivable to make a horizontal slot on the column for the passage of the lug of the plate with or without outward projection.

In the alternative of the closed column shown in FIGS. 5, 5a, 6, the horizontal face (11a2) is rectangular and is integrated in a slot (10a) formed on the accommodating face of the column. It is accordingly necessary to refer to the drawings to describe the practical procedures of use and operation.

In the case of the open column, FIGS. 3, 3a, 4, the safety (3) and traction (2) ropes and the device (11) are accommodated inside the column (10). In the case of the closed column, the said ropes (2-3) and the device (11) are outside the column (10).

The ropes (2-3), at their ends, have stops (13-14) duplicate-moulded or added on or crimped and coming into contact with the inside of the part (11) according to the operating and loading conditions. The stop (13) associated with the traction rope (2) comes into contact with the plate. On the contrary, concerning the safety rope (3), its stop (14) has a loop (14a) for hooking the end of a spring (15) so that the rope is kept under tension, the other end of the spring being joined to the bottom portion of the column by anchoring means (16) of any appropriate type.

For questions of manufacturing standardization, it is obvious that the configuration of the ropes (2-3) and of their stops (13-14) may be identical.

The hooking device (11) of the invention is applicable regardless of the profile of the columns, and it is the particular design of this device that is claimed. Profile arrangements for adapting to the profiles of opened and closed columns of any section may be provided as required.

The solution of the invention provides numerous advantages, with simplicity of manufacture and assembly of the device, and above all, enhanced safety.

1. Device for fastening safety and traction ropes on a telescopic mast of apparatus for lifting boards onto ceilings and walls, comprising a part for hooking the traction and safety ropes being positioned on an internal column of the telescopic mast wherein the part is fixed horizontally on the internal column, and comprises an L shaped plate with a horizontal face and a vertical face connected together by a curved central portion having a wide radius, the plate is arranged with two parallel and identical oblong holes formed in a height of the plate, and the holes allow positioning and passage of the traction and safety ropes, said ropes having at their ends stops coming into contact with a lower side of the plate.

2. Device according to claim 1, wherein the holes have rounded shapes at top and bottom ends, for guidance of the ropes and for preventing deterioration of the ropes by scraping, and the holes extend on the whole curved portion and on part of the horizontal and vertical faces of the plate.

3. Device according to claim 1, wherein the horizontal face of the plate is profiled according to a geometric configuration of the internal column.

4. Device according to claim 3, wherein the horizontal face has a triangular configuration and comes into contact with an opposite wall of the column.

5. Device according to claim 3, wherein the plate is fixed against opposite portions of the column.

6. Device according to claim 4, wherein back-support stops are disposed on insides of the column and serve to stabilize the plate in position.

7. Device according to claim 3, wherein the horizontal face is rectangular and is integrated in a slot formed on an accommodating face of the column.
